(19) United States
(12) Patent Application Publication
(10) Pub. No.: US 2018/0073427 A1
(43) Pub. Date: Mar. 15, 2018

(54) VALVE COVER ASSEMBLY

(71) Applicant: Caterpillar Inc., Peoria, IL (US)

(72) Inventors: Ryan T. Sunley, Washington, IL (US); Bryce L. Tiller, West Lafayette, IN (US); Dennis Gibson, Chillicothe, IL (US)

(73) Assignee: Caterpillar Inc., Peoria, IL (US)

(21) Appl. No.: 15/261,047

(22) Filed: Sep. 9, 2016

(51) Int. Cl. F02B 77/02

(52) U.S. Cl. CPC F02B 77/02

(57) ABSTRACT

A valve cover assembly is provided for an internal combustion engine is provided. It is advantageous to be able to access the various components of an engine valve train without disconnecting of fuel lines that supply fuel to an engine cylinder. The current disclosure provides a valve cover assembly comprising a base with a first cover and a second cover mounted thereon to provide access to the fuel lines and valve train components, respectively. The disclosed valve cover assembly allows fuel lines to be accessed and serviced without disassembly of the first cover. Likewise, the disclosed valve cover assembly allows valve train components to be accessed and services without disassembly of the second cover.

### TECHNICAL FIELD

The present disclosure relates generally to a valve cover assembly, and more particularly to a valve cover assembly for an internal combustion engine having a common rail fuel injection system.

### BACKGROUND

To protect the valve train components of an engine, it is typical to have a cover that seals the fuel injectors, the high pressure fuel lines, and various components of an engine's valve assembly in a fluid tight manner to the cylinder head. Some internal combustion engines use common rail fuel systems in which a pump generates high pressure in a fuel accumulator (the common rail) which feeds fuel via fuel lines to injectors which inject the correct amount of fuel into combustion cylinder chambers. For such engines using a common rail, it is known to have the various valve components of the engine valve assembly be located under a cover with the common rail fuel lines penetrating the valve cover. The various valve components of the engine valve assembly may require need repair, service or adjustment from time to time. It is desirable to avoid disconnection and reconnection of the high pressure fuel lines to avoid introducing debris into the high pressure fuel lines, reduce the risk of fuel leaking if the lines are not reconnected properly.

In International Application Number WO 2015/087105 A1, a valve cover for internal combustion engines with a common rail that has a dividing wall that separates the common rail from the fuel injectors is disclosed. Further aspects of the disclosed valve cover include a service trap door in the cap of the cover to allow access to the common rail without removing the service cover.

In the known cover arrangement wherein the common rail is sealed in the closed volume under the cover, including in the cover arrangement disclosed in WO 2015/087105, when maintenance or service of any part of any part of the valve train assembly, such as setting or adjusting valve lash, the valve cover must be disassembled from the cylinder head to gain access to the mechanical valve component to be serviced. In the known cover arrangement where the common rail fuel lines penetrate the valve cover, access to the valve train components require the high pressure fuel lines of the common rail to be disconnected.

The foregoing background discussion is intended solely to aid the reader. It is not intended to limit the innovations described herein nor to limit or expand the prior art discussed. Thus the foregoing discussion should not be taken to indicate that any particular element of a prior system is unsuitable for use with the innovations described herein, nor is it intended to indicate any element, including solving the motivating problem, to be essential in implementing the innovations described herein. The implementations and application of the innovations described herein are defined by the appended claims.

### SUMMARY OF THE INVENTION

The disclosure describes, in one aspect, a valve cover assembly for an internal combustion engine. The valve cover assembly comprises a base configured for mounting on an engine cylinder head. The base has a sidewall configured for disposition about a plurality of components of the internal combustion engine. The sidewall includes a first surface that is configured to cooperate with the cylinder head and a second surface opposite the first surface. The valve cover assembly also includes a cover support that is positioned on the base and configured to cooperate with the second surface. The cover support defines a first aperture and a second aperture. The valve cover assembly also includes a first cover configured to cooperate with the first aperture and that is configured to allow a fuel line to pass through said first cover. The valve cover assembly further includes a second cover configured to cooperate with the second aperture, said second cover providing access to a plurality of valve components without removal of the first cover.

In another embodiment of the present disclosure, a valve cover assembly for an internal combustion engine is provided. The valve cover assembly includes a base that is configured for mounting on an engine cylinder head. The base has a sidewall that is configured for disposition about a plurality of valve train components of the internal combustion engine. The sidewall includes a first surface configured to cooperate with the cylinder head, and a second surface opposite the first surface. The valve assembly cover further includes a cover support that is positioned on the base, is configured to cooperate with the second surface, and that defines an aperture; The valve cover assembly also includes a first cover that is configured to cooperate with a first portion of the aperture and is also configured to allow a fuel line to pass through said first cover. The valve cover assembly further includes a second cover configured to cooperate with a second portion of the aperture, said second cover providing access to a plurality of valve components without removal of the first cover.

Another embodiment of the present disclosure provides a valve cover assembly for an internal combustion engine. The valve cover assembly includes a base that is configured for mounting on an engine cylinder head. The base defines an aperture and has a sidewall that is configured for disposition about a plurality of valve train components of the internal combustion engine. The sidewall includes a first surface that is configured to cooperate with the cylinder head, and a second surface opposite the first surface. The valve cover assembly includes a first cover that is configured to cooperate with the aperture defined by the base. The first cover is configured to allow a fuel line to pass through the first cover. The valve cover further includes a second that is cover configured to cooperate with the first cover. The second cover provides access to a plurality of valve components without removal of the first cover.

Other features and aspects of this disclosure will be apparent from the following description and the accompanying drawings.

### BRIEF DESCRIPTION OF THE DRAWINGS

The detailed description of the invention below makes reference to the following figures, in which:

FIG. 1 is a perspective view of an internal combustion engine having a valve cover assembly according to one embodiment of the present disclosure;

FIG. 2 is a top view of the valve cover assembly illustrated in FIG. 1 showing a portion of the valve cover assembly removed;

FIG. 3 is schematic sectional view of the valve cover assembly of FIG. 2 along line 4 depicted in FIG.1; and

FIG. 4 is a top view of the valve cover assembly according to an embodiment of the present disclosure, showing a portion of the valve cover assembly removed.

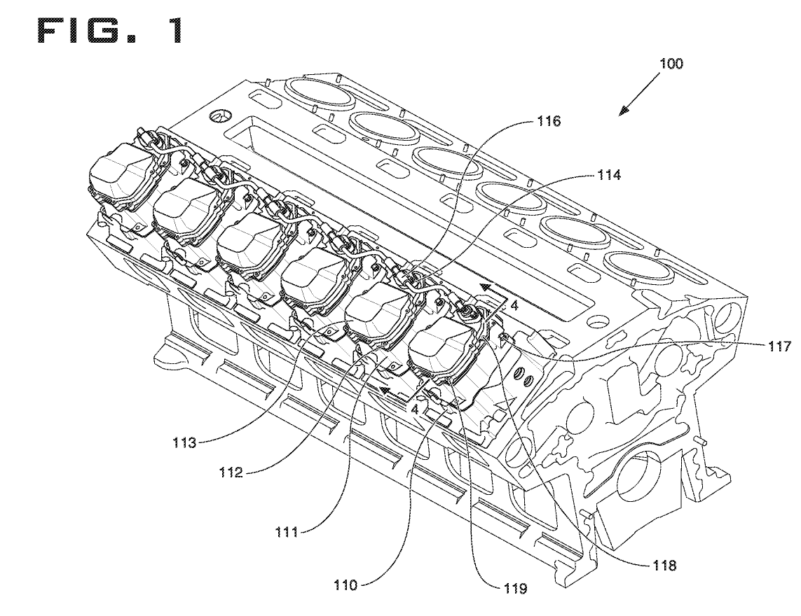

### DETAILED DESCRIPTION

Wherever possible, the same reference numbers will be used throughout the drawings to refer to the same or the like parts. FIG.1 illustrates an exemplary engine 100 according to one embodiment of the present disclosure. For the purposes of this disclosure, engine 100 is depicted and described as a four stroke diesel engine having a common rail fuel system 116. However, one skilled in the art will recognize that engine 100 may be any other type of internal combustion engine including but not limited to a two- or four-stroke gasoline, natural gas, or other gaseous fuel-powered engine. In the illustrated embodiment, the engine 100 is a V-style twelve cylinder engine. However, the number and arrangement of cylinders may vary without limiting the scope of the present disclosure.

As illustrated in FIG. 1, the common rail fuel line may deliver fuel via high pressure fuel line to a fuel injector 114 that introduces fuel into cylinder. The engine 100 may also have a valve cover assembly that contains the valve train components (not shown in FIG. 1) under at least one valve cover 113, with said valve cover(s) allowing access to plurality of valve train components without the disconnection of the common rail fuel line, and also providing access to the common rail fuel line 116 without removal of the valve cover 113.

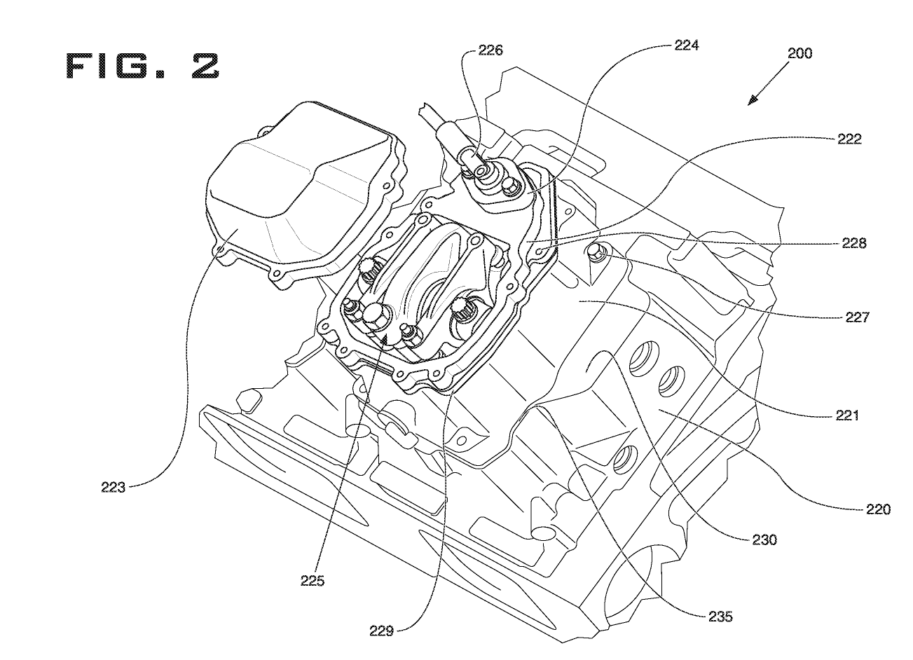

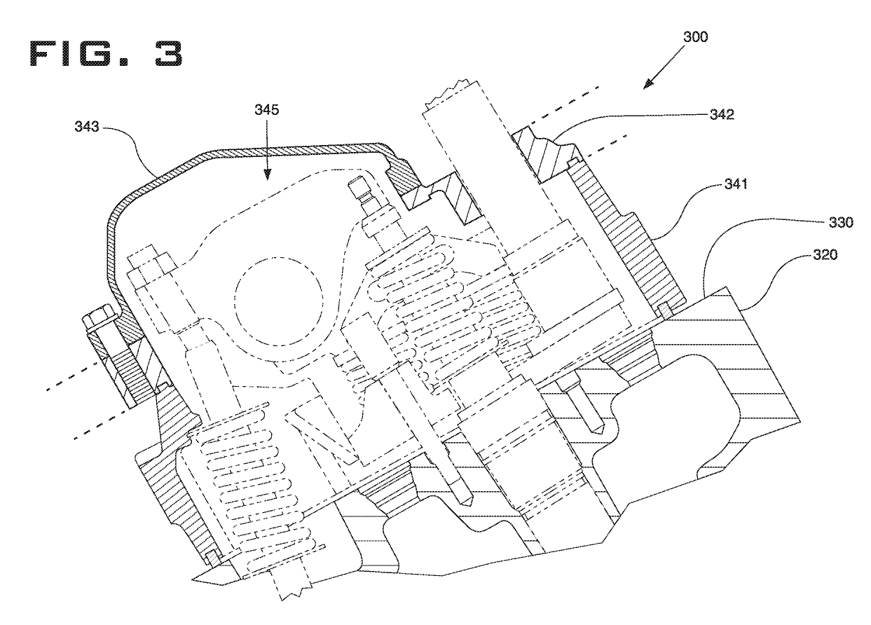

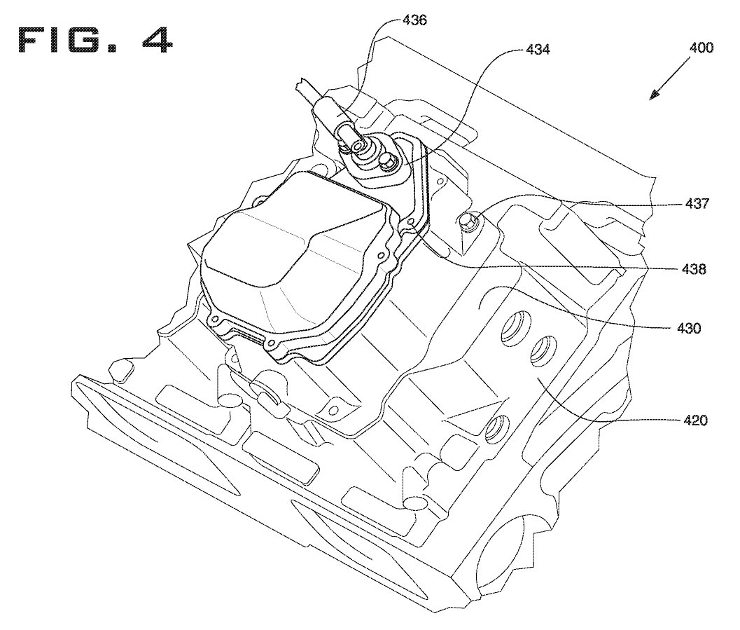

FIG. 2 depicts a perspective view of portion of the exemplary engine 100 having a valve cover assembly 200 according to one embodiment of the present disclosure wherein a first cover 223 is disassembled from the valve cover assembly. FIG. 3 depicts a schematic sectional view of the exemplary engine 100 taken along line 4 as depicted in FIG. 1, having a valve cover assembly 300 according one embodiment of the present disclosure, and FIG. 4 depicts a perspective view of a portion of the exemplary engine 100 having a valve cover assembly 400 according to one embodiment of the present disclosure.

In the illustrated embodiments, valve cover assembly 200, 300, 400 may be mounted on a cylinder head 220. In the illustrated embodiment of the valve cover assembly comprises a base 111, 341 that may be mounted on the cylinder head 220 and that has a sidewall 221. The sidewall 221 may be configured to be disposed around a plurality of valve train components 225, 345 that may include, without limitation, intake valve, exhaust valve, valve seats, and valve springs. The sidewall 221 has, a first surface 229 and a second surface 235 that is opposite the first surface 229. The valve cover assembly 200, 300 may further comprise a cover support 222, 342 that is positioned on the base 111,341, and that is configured to cooperate with the second surface 235 of the base 111, 341 to provide fluid-tight seal between the cover support 222, 342 and base 111, 341. The cover support 222, 342 may define at least one aperture configured to receive one or more of the plurality of valve train components 225, 345, a fuel line, or a fuel injector.

In one embodiment of the present disclosure, the cover support 222 may define two apertures: a first aperture; and a second aperture. One skilled in the art would recognize various ways of arranging the valve train components. The valve cover assembly 200 may further comprise a first cover 224, 434 that is configured to cooperate with a first aperture defined by the cover support 222, 342 that is configured to hold the fuel line or a fuel injector depending on the arrangement of the valve train assembly. A second cover 113, 223, 343 may also be associated with the present disclosure. This second cover 113, 224, 343 may be configured cooperate with a second aperture defined by the cover support 222, 342, and that is configured to hold the plurality of valve train components 225, 345 without removal of the first cover 224, 434. The second cover 113, 224, 343 may further define a volume that is sized to accommodate the plurality of valve train components under said second cover 113, 224, 343.

In one embodiment of the present disclosure, the cover support 222, 342 may be integrated with the first cover 224, 434. Likewise, in another aspect of the present disclosure, the cover support 222, 342 may be integrated with the second cover 113, 224, 343. In another embodiment of the present disclosure, the valve assembly 200, 300, 400 may not have a cover support 222, 342 and the first cover 224, 434and second cover 113, 224, 343 may be mounted directly on the base 111, 341 in an arrangement that provides a fluid tight seal around the plurality of valve train components 225, 345. In yet another embodiment of the present disclosure, the cover support 222, 342 may define one aperture configured to receive all of the plurality of valve train components 225, 345, including a fuel injector, as well as a fuel line; and the first cover 224, 434 may be configured to cooperate with a portion of the aperture and to allow a fuel line to pass through the first cover; with the second cover 113, 224, 343 configured to cooperate with a second portion of the aperture, and to provide access to a plurality of valve train components 225, 345 without removal of the first cover 224, 434.

One of ordinary skill in the art will recognize the need to ensure fluid tight seals between each of the components of the valve cover assembly 200, 300, 400 of the present disclosure. In the present disclosure, bolts 117, 227, 437or bolt holes 119,. 228, 430, are illustrated for connecting the various components of the disclosed valve cover assembly 200, 300, 400. However, one of ordinary skill in the art would recognize and understand the various means for ensuring such fluid tight seals that are known in the art.

### INDUSTRIAL APPLICABILITY

The disclosed valve cover assembly 200, 300, 400 may be implemented in any engine assembly where it is desirable to be able to access various components of an internal combustion engine's valve train 225, 345 without disconnecting fuel line 116, 226 while also allowing access to the fuel line 116, 226. Additionally, the disclosed valve cover assembly 200, 300, 400 may include a first cover 224, 434 that allows the fuel line 116, 226 to be accessed and serviced without disassembling the first cover 224, 434 or any other part of the disclosed valve cover assembly 200, 300, 400.

Significantly, the second cover 113, 224, 343 provides access to the various components of the valve train 225, 345 present within the base 222, 342 in one embodiment, and within the base 111, 341 and the cover support 222, 342 in another embodiment, without disassembling the first cover 224, 434 and without disconnecting the fuel line 116, 226. Therefore, the disclosed valve cover assembly 200, 300, 400 may reduce the time required to perform need service, repair, adjustment, or inspection of the various components of a valve train assembly 225, 345 or the fuel line 116, 226.

Further, accessing the various components of the valve train assembly 225, 345 by only removing the second cover 113, 224, 343 and without having to disconnect the fuel line 116, 226 may reduce the risk the introducing debris into the fuel line that could damage the fuel system. The disclosed valve cover assembly 200, 300, 400 may also reduce the risk of a fuel line 116, 226 not being reconnected correctly after service, repair or inspect of the various components of the valve train assembly 225, 345. Improper reconnection of the fuel line could lead to fuel leaks that could cause damage to valve train or possibly to the engine.

It will be apparent to those skilled in the art that various modifications and variations can be made to the disclosed valve cover assembly 200, 300, 400. Other embodiments will be apparent to those skilled in the art from consideration of the specification and practice of the disclosed valve cover assembly 200, 300, 400. It is intended that the specification and examples be considered as exemplary only, with a true scope being indicated by the following claims and their equivalents.

What is claimed is:

1. A valve cover assembly for an internal combustion engine comprising:
a base configured for mounting on an engine cylinder head, the base having a sidewall configured for disposition about a plurality of valve train components, the sidewall including a first surface configured to cooperate with the cylinder head, and a second surface opposite the first surface;
a cover support positioned on the base and configured to cooperate with the second surface, the cover support defining a first aperture and a second aperture;
a first cover configured to cooperate with the first aperture and configured to allow a fuel line to pass through said first cover; and
a second cover configured to cooperate with the second aperture, said second cover providing access to a plurality of valve train components without removal of the first cover.

2. The valve cover assembly according to claim 1 wherein the second cover defines a volume sized to accommodate the plurality of valve train components under said second cover.

3. The valve cover assembly according to claim 1 wherein the second aperture is sized to accommodate the plurality of valve train components therein.

4. A valve cover assembly for an internal combustion engine comprising:
a base configured for mounting on an engine cylinder head, the base having a sidewall configured for disposition about a plurality of valve train components of the internal combustion engine, the sidewall including a first surface configured to cooperate with the cylinder head, and a second surface opposite the first surface;
a cover support positioned on the base and configured to cooperate with the second surface, the cover support defining an aperture;
a first cover configured to cooperate with a first portion of the aperture and configured to allow a fuel line to pass through said first cover; and
a second cover configured to cooperate with a second portion of the aperture, said second cover providing access to a plurality of valve train components without removal of the first cover.

5. The valve cover assembly according to claim 4 wherein the second cover defines a volume sized to accommodate the plurality of valve train components under said second cover.

6. The valve cover assembly according to claim 4 wherein the aperture is sized to accommodate the plurality of valve train components therein.

7. A valve cover assembly for an internal combustion engine comprising:
a base configured for mounting on an engine cylinder head, the base having a sidewall configured for disposition about the internal combustion engine, the sidewall including a first surface configured to cooperate with the cylinder head and a second surface opposite the first surface, said base defining an aperture;
a first cover configured to cooperate with a first portion of the aperture, and configured to allow a fuel line to pass through said first cover; and
a second cover configured to cooperate with a second portion of the aperture, said second cover providing access to a plurality of valve train components without removal of the first cover.

8. The valve cover assembly according to claim 7 in which the first cover cooperates with the aperture and is configured to allow the fuel line to pass through said first cover; and wherein the second cover cooperates with the first cover.

9. The valve cover assembly according to claim 7 wherein the second cover defines a volume sized to accommodate the plurality of valve train components under said second cover.

10. The valve cover assembly according to claim 7 wherein the aperture is sized to accommodate the plurality of valve train components therein.
